(19) United States
(12) Patent Application Publication
(10) Pub. No.: US 2025/0173367 A1
(43) Pub. Date: May 29, 2025

(54) APPLICATION PROGRAMMING INTERFACE INTENT BASED BEHAVIOR SUMMARIZATION

(71) Applicant: Palo Alto Networks, Inc., Santa Clara, CA (US)

(72) Inventors: Nandini Ramanan, Sunnyvale, CA (US); William Redington Hewlett, II, Mountain View, CA (US); Muhammad Aurangzeb Akhtar, San Jose, CA (US); Manish Mradul, Milpitas, CA (US)

(21) Appl. No.: 18/522,043

(22) Filed: Nov. 28, 2023

(51) Int. Cl. G06F 16/34; G06F 9/54; G06F 40/30

(52) U.S. Cl. CPC G06F 16/345; G06F 9/541; G06F 40/30

(57) ABSTRACT

A generative artificial intelligence (AI) pipeline has been created that employs aspects of natural language processing (NLP) to detect intents of web API calls and then summarizes the behavior expressed by the collective of intents. The pipeline uses a lightweight language model for intent classification of URLs corresponding to API calls in a time interval. The pipeline associates the intent classifications with metadata corresponding to the URLs and feeds this into another lightweight language model that summarizes the intent classifications and metadata. The natural language summarization describes exhibited behavior that can be understood by a wider audience than security experts. The capability to detect intents of API calls occurring in network traffic increases visibility and control of user behavior, particularly in Software-as-a-Service (Saas) environments. Furthermore, the enhanced visibility of user behavior with the created pipeline recognizes new and previously unseen API calls from live network traffic at enterprise scale.

### BACKGROUND

The disclosure generally relates to computing arrangements based on computational models (e.g., CPC G06N) and electrical digital data processing related to handling natural language data (e.g., CPC G06F 40/00).

An application programming interface (API) is an interface for software or programs to communicate with an application or a service for which the API is defined. A specification describes expectations of an API implementation with rules, architecture, and/or protocols. Implementation of an API is usually with a software library and/or function definitions. A “web API” refers to an API that provides an interface for a client (e.g., an application or service) to access a resource of a server (e.g., an application, service, or platform), typically using the Hypertext Transfer Protocol (HTTP). A web API can be a REST or RESTful API, which means the API specification conforms to the representational state transfer architectural design principles.

### BRIEF DESCRIPTION OF THE DRAWINGS

Embodiments of the disclosure may be better understood by referencing the accompanying drawings.

FIG. 1 is a diagram of a generative AI based processing pipeline that generates a description of behavior based on summarization of intents based on API calls.

FIG. 2 is a diagram illustrating an example of the pipeline processing prior to text summarization with examples URLs.

FIG. 3 is a flowchart of example operations for generating a description of behavior based on summarization of API intents.

FIG. 4 is a flowchart of example operations for filtering out events that do not correspond to APIs.

FIG. 5 depicts an example computer system with a multi-language model API intent based behavior summarization pipeline.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “security appliance” as used herein refers to any hardware or software instance for cybersecurity.

A “pipeline” as used herein refers to a set of processing elements (e.g., a software tool, application, process, thread, etc.) arranged in sequence to receive input from a preceding element and output to a next element.

### Overview

A malicious actor can use an API for a cyberattack and can use an API for data leakage, which in some cases is enabled by a cyberattack. An attack in the context of web APIs will involve multiple API calls that collectively exhibit malicious behavior. Detecting this malicious behavior from the API calls is challenging due to network traffic volume, especially at enterprise scale, and dynamicity of APIs (change to existing APIs, new APIs). A generative artificial intelligence (AI) pipeline has been created that employs aspects of natural language processing (NLP) to detect intents of web API calls and then summarizes the behavior expressed by the collective of intents. The pipeline uses a lightweight language model for intent classification of URLs corresponding to API calls in a time interval. The pipeline associates the intent classifications with metadata corresponding to the URLs and feeds this into another lightweight language model that summarizes the intent classifications and metadata. The natural language summarization describes exhibited behavior in a manner that can be understood by a wider audience than security experts. The capability to detect intents of API calls occurring in network traffic increases visibility and control of user behavior, particularly in Software-as-a-Service (SaaS) environments. Furthermore, the enhanced visibility of user behavior with the created pipeline recognizes new and previously unseen API calls from live network traffic at enterprise scale.

### Example Illustrations

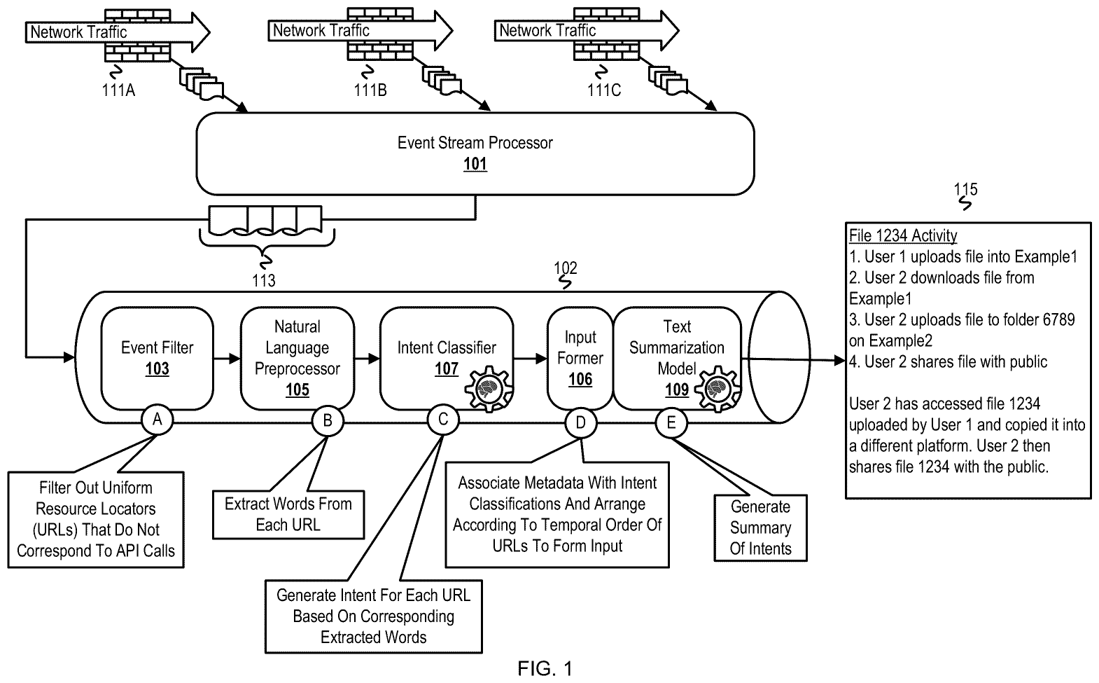

FIG. 1 is a diagram of a generative AI based processing pipeline that generates a description of behavior based on summarization of intents of API calls. A language model based pipeline 102 includes an event filter 103, a natural language preprocessor 105, an intent classifier 107, an input former 106, and a text summarization model 109. In this illustration, the pipeline 102 receives events from an event stream processor 101. The event stream processor 101 receives network traffic logs as events from security appliances 111A-111C. The security appliances 111A-111C can be labeled as producers or publishers while the pipeline 102 can be labeled as a subscriber or consumer. The event stream processor 101 communicates network traffic logs that indicate URLs. Regardless of the paradigm or architecture of the event stream processor 101, events stream to the pipeline 102. FIG. 1 depicts a set of events 113 to represent events within a time interval. The time interval can be defined as part of the pipeline 102 registering interest in the events with the event stream processor 101 and influencing how the events are communicated to the pipeline 102. The pipeline 102 may select or identify events of a time interval within a stream or queue events per time interval.

FIG. 1 is annotated with a series of letters that each represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the event filter 103 receives traffic logs in a time interval and filters out traffic logs with URLs that do not correspond to API calls. The network traffic logs communicated to the pipeline 102 are already limited to those with URLs detected therein. Since the pipeline analysis is based on API calls, the event filter 102 filters out traffic logs with URLs that do not correspond to APIs. This filtering can be implemented based on keyword detection, machine learning (e.g., regression analysis), or a combination that incorporates keywords into features for analysis by a machine learning model. The event filter 103 passes the URLs of filtered traffic logs to the natural language preprocessor 105.

At stage B, the natural language preprocessor 105 preprocesses URLs of the filtered traffic logs to extract words from each URL. Preprocessing to extract words can be parsing based on formatting (e.g., camelCase), removing symbols, word recognition, expanding abbreviations, etc. The extracted words may be grouped as sentences in the simplest sense of natural language processing, such as having a word that is a subject and a word that is predicate. The natural language preprocessor 105 passes the extracted words of each URL to the intent classifier 107.

At stage C, the intent classifier 107 generates an intent classification for each set of words or sentence extracted from a URL. The intent classifier 107 can be a lightweight language model (i.e., less than a billion parameters) pre-trained for intent classification or fine-tuned for intent classification. For example, a encoder-decoder model (e.g., t5-small) that has been pre-trained for multiple tasks can be fine-tuned for intent classification in the domain of APIs. To create a dataset for fine-tuning a language model, API specifications are crawled to extract field names and field descriptions. The information from crawling API specifications such as structure and content of requests, responses, objects, etc. informs intent classification. Input-output pairs are created by extracting sentences from URLs and creating a label (i.e., an intent classification) based on the extracted words and information from crawling the API specifications. An objective function that measures dissimilarity can be used for training (e.g., binary cross-entropy loss function). Training of the model can be according to teacher forcing technique. The intent classifier 107 passes the generated intent classifications to the input former 106.

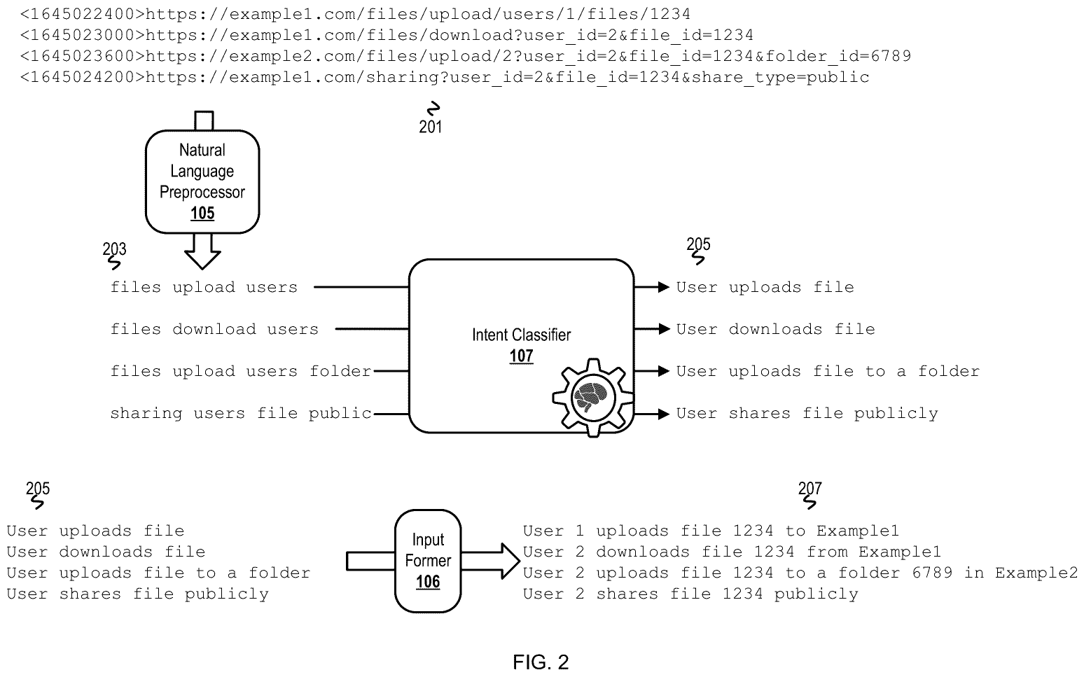

At stage D, the input former 106 forms an input based on the intent classifications from the intent classifier 107. The input former 107 determines values relevant to the intent classifications from the URLs and/or from metadata of the traffic logs. A reference is maintained between each URL and the corresponding event/traffic log to allow elements in the pipeline to access corresponding metadata. For each intent classification, the input former 107 identifies the corresponding traffic log, extracts any relevant value from the URL and/or metadata of the traffic log, and associates the value(s) with the intent classification in the input being formed. An intent classification associated with a value(s) will be referred to as the intent. To illustrate, the intent classification “user uploads file” is associated with values to become the intent “user XYZ uploads file 1234 to platform EXAMPLE.” The input former 106 then arranges the intents according to temporal order of the URLs to form the input to the text summarization model 109. Temporal order is determined based on metadata of the traffic logs (e.g., timestamps). FIG. 2 will now be described to provide an illustration with example URLs.

FIG. 2 is a diagram illustrating an example of the pipeline processing prior to text summarization with example URLs. A set of example URLs 201 are filtered URLs (i.e., already determined as corresponding to APIs) within a time interval. These URLs 201 are fed into the natural language preprocessor 105. The depicted URLs 201 are

<1645022400>https://example1.com/files/upload/users/1/files
/1234
<1645023000>https://example1.com/files/download?user_id=2&f
ile_id=1234
<1645023600>https://example2.com/files/upload/2?user_id=2&f
ile_id=1234&folder_id=6789
<1645024200>https://example1.com/sharing?user_id=2&file_id=
1234&share_type=public

For the first URL, the natural language preprocessor 105 extracts the words “files upload users.” For the second URL, the natural language preprocessor 105 extracts the words “files download users.” For the third URL, the natural language preprocessor 105 extracts the words “files upload users folder.” For the fourth URL, the natural language preprocessor 105 extracts the words “sharing users file public.” Based on the extracted words 203, the intent classifier 107 generates intent classifications 205.

| Extracted Words | Intent Classifications |
|---|---|
| files upload users | User uploads file |
| files download users | User downloads file |
| files upload users folder | User uploads file to a folder |
| sharing users file public | User shares file publicly |

The intent classifications 205 are fed into the input former 106. The input former 106 extracts values from the URLs and/or metadata to associate values with the intent classifications to produce intents 207 according to the temporal order of the URLs.

| Intent Classifications | Intents |
|---|---|
| User uploads file | User 1 uploads file 1234 to Example1 |
| User downloads file | User 2 downloads file 1234 from |
| | Example1 |
| User uploads file to a folder | User 2 uploads file 1234 to a folder 6789 |
| | in Example 2 |
| User shares file publicly | User 2 shares the file 1234 publicly |

The input former 106 can determine relevant values by parsing the URL according to the intent classification. For example, the input former 106 (or a parser used by the input former 106) parses a URL based on a known format of the URL for an API to extract values based on the corresponding word(s) in the intent classification. The input former 106 can also examine fields and values in metadata of the traffic log to extract relevant values.

Returning to FIG. 1, the text summarization model 109 generates a description of the behavior represented by the intent classification at stage E. Using the example illustrated in FIG. 2, the text summarization model 109 generates a summary 115 that lists the intents and describes suspicious behavior of User 2. This can be used to investigate an incident that has occurred or interrupt an ongoing attack or leak.

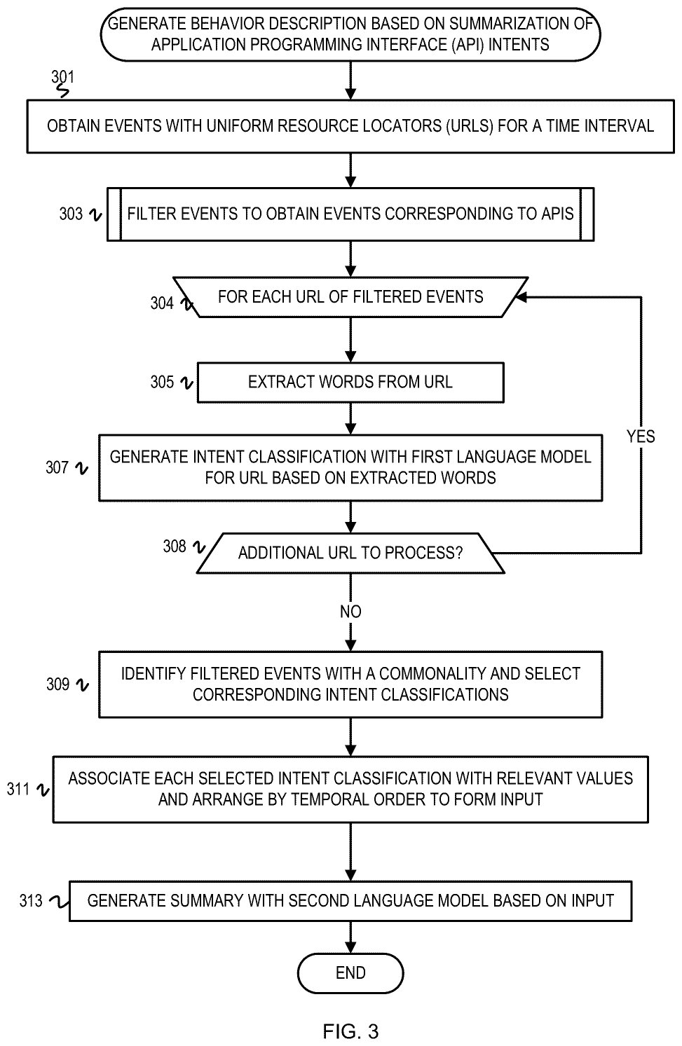

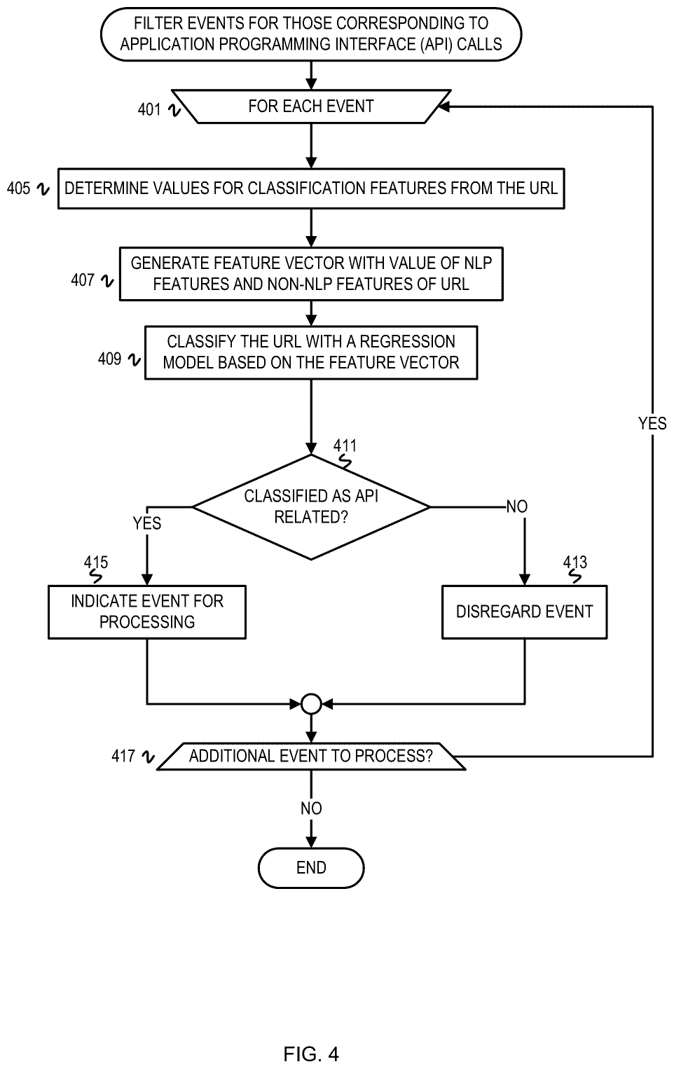

FIGS. 3 and 4 are a flowcharts of example operations for gleaning API based behavior from network traffic logs using machine learning/AI. The example operations are described with reference to a multi-language model based pipeline for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for generating a description of behavior based on summarization of API intents. While the description refers to the pipeline when describing operations generally, some operations are described with reference to the language models. The models are referenced specifically because design of the pipeline can vary across implementations, but implementations will include the two language models. The description refers to events with URLs because the network traffic data may be communicated in another format or structure than a network traffic log. For example, inline traffic analysis can detect API URLs while a user interacts with a Software-as-a-Service application.

At block 301, a multi-language model based pipeline obtains events with URLs for a time interval. The pipeline can retrieve events within a specified time interval or select already received events within a specified time interval. The analysis by the pipeline can be in “real-time,” meaning that the events are processed proximate to occurrence of the events (e.g., within s seconds of an end of a time interval). However, the pipeline can be run on historical events, for example to investigate an already detected non-compliant access of organization data or a cyberattack that has already occurred.

At block 303, the pipeline filters events to filter out events that do not correspond to APIs. The operation refers to filtering out the events instead of just filtering out URLs since the events include other information (e.g., timestamps or message body metadata) incorporated later. Example operations for block 303 are depicted in FIG. 4 which will be described after FIG. 3.

At block 304, the pipeline begins processing each URL of the filtered events. The processing involves determining intent classifications for each of the URLs.

At block 305, the pipeline extracts words from the URL. The URL is tokenized to extract words. In some cases, a token may be further processed to extract a word(s) (e.g., expanding abbreviations). For example, a URL may contain words that are concatenated together in camel case format, such as “getUserById”. Tokenizing produces the token “getUserById” and then parsing based on recognizing the camel case format produces the words “get” and “user.” For instance, a regular expression (regex) replacement function can be used on the token. A URL may contain a blended word, such as “getuserbyid”. To separate these words, the pipeline can use a soft version of the Viterbi algorithm. For abbreviations, the tokens remaining after other processing can be compared against a listing/indexing of abbreviations and the expanded words. For instance, the pipeline would look up token “qos” and resolve to “quality of service,” or the token “dnd” and resolve to “do not disturb.” This is not necessary for the intent classification but improves readability in the natural language generation for the summary. Additional processing of the URL can be done to reduce the size of the vocabulary for the intent classifier to learn. For instance, the pipeline can remove punctuation and alphanumeric characters specified as not relevant to the meaning of the URL.

At block 307, the pipeline generates an intent classification for the URL based on the extracted words. The extracted words are encoded for a language model (e.g., with one-hot encoding) and then input to the language model being used as an intent classifier to generate the intent classification. As previously mentioned, the language model can be a lightweight, pre-trained language model that has been fine tuned for API intent classification. Embodiments are not limited to a lightweight language model and not limited to fine-tuning. For instance, few shot prompting could be used for a language model to classify intent of APIs based on words extracted from API related URLs.

At block 308, the pipeline determines whether there is another URL of the filtered events to process. If there is another URL to process, then operational flow returns to block 304. Otherwise, operational flow proceeds to block 309.

At block 309, the pipeline identifies filtered events with a commonality and selects corresponding intent classifications. At enterprise scale, the events being processed can be from thousands of users across multiple locations. Furthermore, an enterprise may have assets across many instances in multiple cloud-based platforms. To obtain a coherent view, filtered events having a commonality (e.g., a common attribute such as user(s) or file) are identified. Identification of events having a commonality can be based on scanning the events for metadata (e.g., key-value pairs) that satisfy a selection criteria. One or more criteria for this commonality can be entered via an interface or be specified in a configuration. As an example, the pipeline can be configured to identify any file or user indicated in a threshold number of events and then select those events that indicate at least one of the file and user.

At block 311, the pipeline forms an input for the next language model with the selected intent classifications (i.e., those intent classifications corresponding to the events identified as having a commonality) and relevant values. The pipeline determines, for each intent classification, any relevant values to associate with the intent classification. Relevant values can be determined based on keywords in the intent classifications mapping to values assigned to fields in metadata (e.g., response body) indicated in the event of the URL corresponding to the intent classification. A relevant value may be in the URL itself. With a known path format of an API, the pipeline can determine a relevant value in a URL based on a word in the intent classification. The pipeline then arranges the API intents (i.e., intent classifications associated with relevant values) in temporal order of the events to form the input. In some cases, the events are arranged in temporal order according to event timestamps prior to the pipeline or at the beginning of the pipeline after filtering and the order is preserved throughout. In that case, the pipeline validates the order of the intent classifications.

At block 313, the pipeline generates a summary with a second language model based on the input. Additional training is not necessary for the second language model, assuming it has been pre-trained for text summarization. The input or prompt is fed into the second language model which generates a summary that describes behavior as represented or suggested by the API intents in a more human readable narrative.

FIG. 4 is a flowchart of example operations for filtering out events that do not correspond to API calls. The example operations presume use of a regression model to classify a URL as related to an API or not related to an API. Embodiments do not necessarily use machine learning and can use keyword matching. However, using machine learning for filtering events provides a more dynamic and flexible process.

At block 401, the pipeline begins processing each event of a set of events. The events occur within a time interval or time window either pre-defined or specified as a configuration or input, for example.

At block 405, the pipeline determines values for features to classify whether a URL corresponds to an API. Values of the features are determined from the URL. Features may be encoded in the URL or be an attribute of a URL. Examples of features include HTTP request methods in the URL, API specific authentication parameters or tokens occurring in the URL, version numbers or release dates indicated in the URL, file formats indicated in the URL, resource identifiers in the URL, specific HTTP headers in the URL, API specific query parameters in the URL, characters or symbols or combinations thereof, length of the URL, and keywords in the URL.

At block 407, the pipeline generates a feature vector with the values of the features. Some of the feature values, such as keywords, are encoded for the language model to consume.

At block 409, the pipeline classifies the URL with a regression model based on the feature vector. The regression model will have been trained according to the features that have been selected as indicative of an API. The feature vector is input to the regression model and a classification for the URL is output.

At block 411, the pipeline determines the classification output by the regression model. If the URL is classified as related to an API, then operational flow proceeds to block 415. If the URL has been classified as not related to an API, then operational flow proceeds to block 413. At block 413, the event is disregarded. For instance, the event is removed from the set of events being processed. At block 415, the pipeline indicates the event for processing. The operation of block 415 is optional. It can be implicit that an event is to be further processed in the pipeline if it still remains after filtering.

At block 417, the pipeline determines whether there is an additional event to process. If there is an additional event to process, then operational flow returns to block 401. If there was not an additional event to process, then operational flow terminates.

### Variations

FIG. 3 describes a single iteration for filtered events, but implementations can vary. For instance, the operations can continue for each set of events for each successive time interval. With respect to selecting events having a commonality, filtered events may include multiple sets of events with overlapping or disparate commonality. In that case, an input would be formed for each set of events having a commonality and multiple summaries generated. In the case of overlapping commonality, an API intent may be selected multiple times.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, multiple instances of blocks 309, 311, 313 can be instantiated when multiple sets of filtered events are to be summarized for different commonalities. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

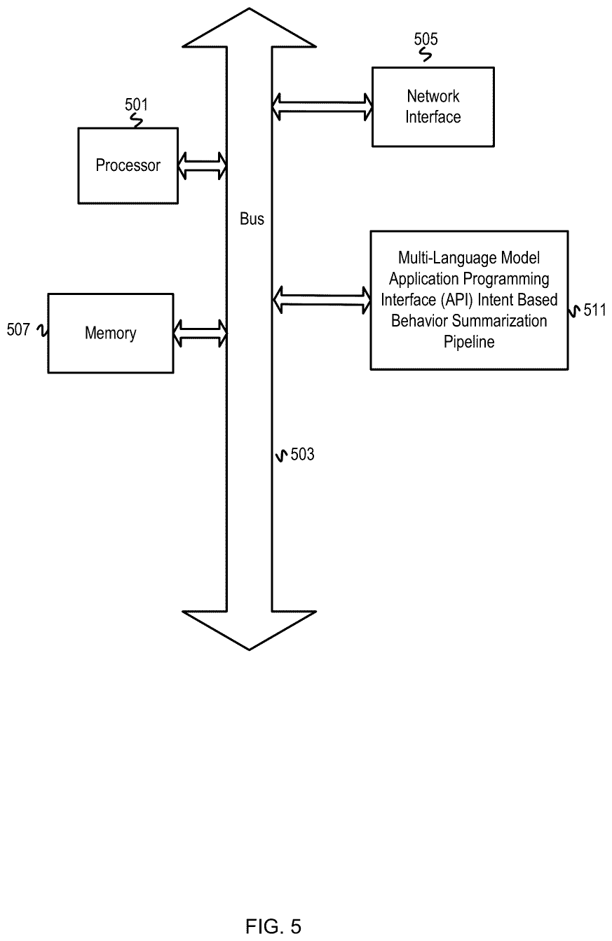

FIG. 5 depicts an example computer system with a multi-language model API intent based behavior summarization pipeline. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a multi-language model API intent based behavior summarization pipeline (“pipeline”) 511. The pipeline 511 uses two lightweight language models to determine intents of APIs or API calls as represented by URLs detected in events/network traffic logs and summarizes the API intents into a description of behavior across a time interval that includes the events corresponding to the URLs. The pipeline 511 processes events of different time intervals and filters events in a time interval to select those with URLs related to an API. The first language model generates intent classifications for URLs based on words extracted from the URLs. The second language model describes behavior represented by a set of filtered events by summarizing API intents across the time interval. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
generating sentences based, at least in part, on a first plurality of uniform resource locators (URLs) of a first time window, wherein each of the first plurality of URLs corresponds to one or more application programming interfaces (APIs);
determining, with a first language model, a first plurality of intents of the first plurality of URLs based, at least in part, on the sentences of the URLs;
forming a first input according to temporal order of the first plurality of URLs, wherein the first input is formed with the first plurality of intents and metadata associated with the first plurality of URLs; and
generating a summary of the first plurality of intents with a second language model based, at least in part, on the first input.

2. The method of claim 1 further comprising extracting a second plurality of URLs and corresponding metadata from network traffic data and determining which of the second plurality of URLs corresponds to one or more APIs to obtain the first plurality of URLs.

3. The method of claim 2, wherein determining which of the second plurality of URLs corresponds to an API comprises classifying each URL of the second plurality of URLs as corresponding to an API or not corresponding to an API with a regression model based, at least in part, on features of the URL.

4. The method of claim 1, wherein generating the sentences comprises, for each of the first plurality of URLs, determining at least one of a subject and a verb based, at least in part, on the URLs.

5. The method of claim 4, wherein generating the sentences further comprises, for each of the first plurality of URLs, determining at least one of a subject and a verb from metadata associated with the URL.

6. The method of claim 4, wherein generating the sentences comprises, for each of the first plurality of URLs, tokenizing the URL based on camel case detection, tokenizing a blended word with the soft version of the Viterbi algorithm, detecting an abbreviation and expanding the abbreviation, and removing punctuation.

7. The method of claim 1 further comprising selecting the first plurality of intents from a second plurality of intents based on a common attribute of the first plurality of URLs, wherein the second plurality of intents corresponds to a second plurality of URLs, wherein the first plurality of URLs is a subset of the second plurality of URLs.

8. The method of claim 1 further comprising, for each of the first plurality of URLs, extracting at least one of an application name, a path parameter, and a query parameter from metadata of the URL.

9. The method of claim 1, wherein the first language model is smaller than a large language model.

10. A non-transitory, machine-readable medium having program code stored thereon, the program code comprising instructions to:
determine uniform resource locators (URLs) indicated in network traffic logs that correspond to application programming interface (API) calls;
preprocess the URLs to extract words;
for each of the URLs, determine an intent with a first language model based on the words of the URLs;
form a first input for a second language model based, at least in part, on the intents, metadata, and temporal order of at least a subset of the URLs; and
generate a summary of the intents with the second language model based on the first input.

11. The non-transitory, machine-readable medium of claim 10, wherein the instructions to determine URLs in network traffic logs that correspond to API calls comprise instructions to generate feature vectors for URLs indicated in the network traffic logs based on the URLs and metadata associated with the URLs in the traffic logs and classify the URLs with a classifier based on the feature vectors.

12. The non-transitory, machine-readable medium 11, wherein the program code further has stored thereon instructions to generate a dataset to train the first language model, wherein the instructions to generate the dataset comprise instructions to crawl one or more API specifications to extract words and intent classifications.

13. The non-transitory, machine-readable medium 10, wherein the instructions to preprocess the URLs to extract words comprise instructions to, at least one of:
tokenize the URL based on camel case detection;
tokenize a blended word with the soft version of the Viterbi algorithm;
detect an abbreviation and expand the abbreviation; and
remove punctuation.

14. The non-transitory, machine-readable medium of claim 10, wherein the first and the second language models are lightweight transformer-based language models.

15. The non-transitory, machine-readable medium 10, wherein the network traffic logs indicate network traffic occurring within a specified time window at a set of one or more security appliances.

16. The non-transitory, machine-readable medium of claim 10, wherein the program code further comprises instructions to select the subset of the URLs based on a common attribute.

17. An apparatus comprising:
a processor; and
a machine-readable medium having instructions stored thereon that are executable by the processor to cause the apparatus to,
determine uniform resource locators (URLs) indicated in network traffic logs that correspond to application programming interface (API) calls;
preprocess the URLs to extract words;
for each of the URLs, determine an intent with a first language model based on the words of the URLs;
form a first input for a second language model based, at least in part, on the intents, metadata, and temporal order of at least a subset of the URLs; and
generate a summary of the intents with the second language model based on the first input.

18. The apparatus of claim 17, wherein the instructions to determine URLs in network traffic logs that correspond to API calls comprise instructions executable by the processor to cause the apparatus to generate feature vectors for URLs indicated in the network traffic logs based on the URLs and metadata associated with the URLs in the traffic logs and classify the URLs with a classifier based on the feature vectors.

19. The apparatus of claim 18, wherein the machine-readable medium further has stored thereon instructions executable by the processor to cause the apparatus to generate a dataset to train the first language model, wherein the instructions to generate the dataset comprise instructions to crawl one or more API specifications to extract words and intent classifications.

20. The apparatus of claim 17, wherein the first and the second language models are small or tiny transformer-based language models.
